(19) United States
(12) Patent Application Publication
(10) Pub. No.: US 2013/0141036 A1
(43) Pub. Date: Jun. 6, 2013

(54) CHARGEABLE CASE OF ELECTRONIC DEVICE AND CHARGING SYSTEM

(71) Applicants: CHUN-MEI YI, Shenzhen City (CN); YONG-QUN TAO, Shenzhen City (CN); GANG WANG, Shenzhen City (CN); CHUN-WEI PAN, Tu-Cheng (TW)

(72) Inventors: CHUN-MEI YI, Shenzhen City (CN); YONG-QUN TAO, Shenzhen City (CN); GANG WANG, Shenzhen City (CN); CHUN-WEI PAN, Tu-Cheng (TW)

(73) Assignees: HON HAI PRECISION INDUSTRY CO., LTD., Tu-Cheng (TW); HONG FU JIN PRECISION INDUSTRY (ShenZhen) CO., LTD., Shenzhen City (TW)

(21) Appl. No.: 13/330,557

(22) Filed: Dec. 19, 2011

(30) Foreign Application Priority Data
Dec. 5, 2011 (CN) 201120499676.1

(51) Int. Cl. H02J 7/00

(52) U.S. Cl. 320/108

(57) ABSTRACT

A chargeable case of an electronic device includes an envelop body for enveloping an electronic device therein, a receiving coil, a power output interface and a built-in AC/DC rectifying circuit. The receiving coil wirelessly receives alternating current from a power supply device. The power output interface connects a power input interface of the electronic device. The AC/DC rectifying circuit is connected the receiving coil and the power output interface. The AC/DC rectifying circuit converts the received alternating current into direct current and supplies the direct current to the power output interface for charging the electronic device. A charging system is also disclosed.

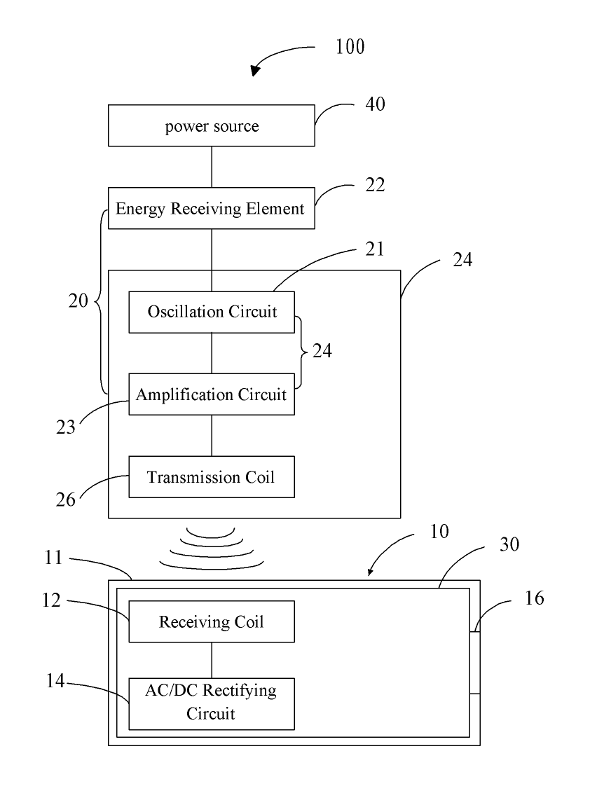

### BACKGROUND

1. Technical Field

The present disclosure relates to a chargeable case of an electronic device and a charging system.

2. Description of Related Art

Wireless chargeable electronic devices have a receiving coil for receiving alternating current from a wireless chargeable device, which increases the weight of the electronic device and negatively impacts the layout of elements in the electronic device.

What is needed, therefore, is a charging system for charging the electronic device to overcome the above-described problems.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the views.

The FIGURE is a block diagram of a charging system.

### DETAILED DESCRIPTION

The FIGURE, a charging system 100 includes a chargeable case 10 and a wireless transmission member 20. The chargeable case 10 receives electrical energy transmitted by the wireless transmission member 20, to recharge an electronic device 30. A power source 40 provides the electrical energy to the wireless transmission member 20.

The wireless transmission member 20 includes an energy receiving element 22, a transmission circuit 24 and a transmission coil 26. The energy receiving element 22 is configured for receiving the electrical energy from the power source 40. The power source 40 may be a house power supply. The transmission circuit 24 includes an oscillation circuit 21 and an amplification circuit 23. The oscillation circuit 21 is connected to the energy receiving element 22. The oscillation circuit 21 converts the received electrical energy into alternating current with a predetermined frequency. The amplification circuit 23 is connected to the oscillation circuit 21. The amplification circuit 23 amplifies the alternating current generated by the oscillation circuit 21. The transmission coil 26 is connected to the amplification circuit 23. The transmission coil 26 transmits the amplified alternating current to the chargeable case 10.

The chargeable case 10 includes an envelop body 11 for enveloping the electronic device 30 therein, a receiving coil 12, a built-in AC/DC rectifying circuit 14 and a power output interface 16. The envelop body 11 is comprised of elastic material and is deformable. The receiving coil 12 is connected to the AC/DC rectifying circuit 14. The receiving coil 12 is formed in the envelop body 11. The receiving coil 12 receives the amplified alternating current from the transmission coil 26 and transmits the amplified alternating current to the AC/DC rectifying circuit 14. The AC/DC rectifying circuit 14 is connected to the power output interface 16. The AC/DC rectifying circuit 14 converts the amplified alternating current into direct current and outputs the direct current to the output power interface 16. The power output interface 16 is formed on and exposed at the envelop body 11 and connects a power input interface (not shown) of the electronic device 30. When the electronic device 30 is received in the envelop body 11, the power output interface 16 is aligned with the power input interface and connected to the power input interface, the direct current are supplied to the electronic device 30 for recharging the electronic device 30.

It is to be understood, however, that even though numerous characteristics and advantages of the present disclosure have been set fourth in the foregoing description, together with details of the structure and function of the present disclosure, the present disclosure is illustrative only, and changes may be made in detail, especially in matters of shape, size, and arrangement of parts within the principles of the present disclosure to the full extent indicated by the broad general meaning of the terms in which the appended claims are expressed.

What is claimed is:

1. A chargeable case for encasing and recharging an electronic device, comprising:
an envelop body for enveloping an electronic device therein;
a receiving coil formed in the envelop body and configured for wirelessly receiving alternating current from a power supply device;
a power output interface formed on and exposed at the envelop body and configured for electrically connecting to a power input interface of the electronic device; and
a built-in AC/DC rectifying circuit connecting the receiving coil and the power output interface, the AC/DC rectifying circuit configured for converting the received alternating current into direct current and supplying the direct current to the power output interface for recharging the electronic device.

2. The chargeable case as described in claim 1, wherein the envelop body is comprised of elastic material and is deformable.

3. A charging system comprising:
a wireless transmission member comprising:
an energy receiving element configured for receiving electrical energies from a power source;
a transmission circuit connected to the energy receiving element and configured to convert the electrical energies into alternating current with a predetermined frequency; and
a transmission coil configured to transmit the alternating current; and
a chargeable case comprising:
an envelop body for enveloping an electronic device therein;
a receiving coil formed in the envelop body and configured for wirelessly receiving the alternating current from a transmission coil;
a power output interface formed on and exposed at the envelop body and configured for electrically connecting to a power input interface of the electronic device; and
a built-in AC/DC rectifying circuit connecting the receiving coil and the power output interface, the AC/DC rectifying circuit configured for converting the received alternating current into direct current and supplying the direct current to the power output interface for recharging the electronic device.

4. The charging system as described in claim 3, wherein the envelop body is comprised of elastic material and is deformable.
